(19) United States
(12) Patent Application Publication
(10) Pub. No.: US 2024/0410996 A1
(43) Pub. Date: Dec. 12, 2024

(54) RANGING DEVICE AND RANGING METHOD

(71) Applicant: CANON KABUSHIKI KAISHA, Tokyo (JP)

(72) Inventors: YUYA KAWANO, Kanagawa (JP); KAZUNORI MATSUYAMA, Kanagawa (JP); TAKEAKI ITSUJI, Kanagawa (JP)

(21) Appl. No.: 18/675,589

(22) Filed: May 28, 2024

(30) Foreign Application Priority Data
Jun. 7, 2023 (JP) 2023-094109

(51) Int. Cl. G01S 7/487; G01S 7/481; G01S 17/58; G01S 17/931

(52) U.S. Cl. CPC G01S 7/487; G01S 7/4816; G01S 17/58; G01S 17/931

(57) ABSTRACT

A ranging device includes a light receiving unit of converting optical signal including light emitted from a light emitting unit and reflected by an object into pulse signal, a control unit of setting the light receiving unit to one of exposure periods corresponding classes defined according to time from emission to detection for each emission of light, an information generation unit of generating information indicating a relationship between the class and a frequency indicating the number of pulse signals, based on signal output from the light receiving unit during a frame, and a peak determination unit of determining a peak of the frequency in the information. When the peak is detected in the information acquired in a first frame, in the next second frame, the control unit sets as the exposure period in order from a period closer to a period corresponding to a class the peak is detected.

### BACKGROUND

### Field of the Disclosure

The present disclosure relates to a ranging device and a ranging method.

### Description of the Related Art

As one of ranging methods for measuring a distance to an object using light, a ranging method called a TOF (Time Of Flight) method is known. The TOF method is a method of measuring a distance to an object based on a time from emission of light toward the object to detection of light reflected by the object. In U.S. Patent Application Publication No. 2017/0052065, a ranging device is described which measures a distance to an object by applying a TOF method to a photon detection sensor using a SPAD (Single Photon Avalanche Diode) element.

In the ranging method described in U.S. Patent Application Publication No. 2017/0052065, a short-pulse laser beam that repeatedly emits light at a predetermined frequency is irradiated toward an object, and reflected light from the object is detect with synchronizing the irradiation of the laser beam and the detection by the SPAD sensor with each other. That is, a specific exposure period (gating period) is set in association with the emission timing of the laser beam in the SPAD sensor, and photon detection is performed in the exposure period. Then, the exposure period is sequentially shifted, and signals corresponding to each of the plurality of exposure periods are acquired. This result is recorded in the histogram memory, and the distance to the object is calculated from the histogram peak.

However, in the technique described in U.S. Patent Application Publication No. 2017/0052065, since the histogram information along the depth direction of the distance measuring range is acquired by performing measurement while sequentially shifting the exposure period, it takes time to generate the histogram information, and the frame rate may decrease.

### SUMMARY

An object of the present disclosure is to provide a technique for reducing a time required to acquire distance information in a ranging device and a ranging method that acquire distance information along a depth direction of a distance measurement range by performing measurement while sequentially shifting an exposure period.

According to one disclosure of the present specification, there is provided a ranging device including a light receiving unit configured to detect an optical signal including light emitted from a light emitting unit and reflected by an object in a measurement target region and convert the optical signal into a pulse signal, an exposure period control unit configured to set the light receiving unit to one of a plurality of exposure periods set corresponding to a plurality of classes defined according to a time from emission of the light to detection of the light for each light emission of the light emitting unit, an information generation unit configured to generate information indicating a relationship between the class and a frequency indicating the number of times the pulse signal is detected, based on a signal output from the light receiving unit during a predetermined frame period including a plurality of light emissions of the light emitting unit, and a peak determination unit configured to determine a peak of the frequency in the information, wherein, when the peak of the frequency is detected in the information acquired in a first frame period, in a second frame period subsequent to the first frame period, the exposure period control unit sets as the exposure period in order from a period closer to a period corresponding to a class in which the peak is detected.

Further, according to another disclosure of the present specification, there is provided a ranging device including a light receiving unit configured to detect an optical signal including light emitted from a light emitting unit and reflected by an object in a measurement target region and convert the optical signal into a pulse signal, an exposure period control unit configured to set the light receiving unit to one of a plurality of exposure periods set corresponding to a plurality of classes defined according to a time from emission of the light to detection of the light for each light emission of the light emitting unit, an information generation unit configured to generate information indicating a relationship between the class and a frequency indicating the number of times the pulse signal is detected, based on a signal output from the light receiving unit during a predetermined frame period including a plurality of light emissions of the light emitting unit, and a distance information acquisition unit configured to acquire distance information related to the object from outside, wherein the exposure period control unit sets the exposure period as the exposure period in order from a period closer to a period corresponding to the distance information acquired by the distance information acquisition unit.

According to still another disclosure of the present specification, there is provided a ranging method that detects an optical signal including light emitted from a light emitting unit and reflected by an object in a measurement target region and calculates a distance to the object based on the detected signal, the method including setting a light receiving unit to one of a plurality of exposure periods set corresponding to a plurality of classes defined according to a time from emission of the light to detection of the light for each light emission of the light emitting unit, and converting a signal detected by the light receiving unit to a pulse signal, generating information indicating a relationship between the class and a frequency indicating the number of times the pulse signal is detected, based on a signal output from the light receiving unit during a predetermined frame period including a plurality of light emissions of the light emitting unit, and when the peak of the frequency is detected in the information acquired in a first frame period, in a second frame period subsequent to the first frame period, setting as the exposure period in order from a period closer to a period corresponding to a class in which the peak is detected.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a ranging device according to a first embodiment.

FIG. 2 is a timing chart illustrating a basic operation of the ranging device according to the first embodiment.

FIG. 3 is a diagram explaining a method of acquiring distance information in the ranging device according to the first embodiment.

FIG. 4 is a diagram explaining a first measurement mode in the ranging device according to the first embodiment.

FIG. 5 is a diagram explaining a second measurement mode in the ranging device according to the first embodiment.

FIG. 6 and FIG. 7 are flowcharts illustrating the operation of the ranging device according to the first embodiment.

FIG. 8A, FIG. 8B, FIG. 9A, and FIG. 9B are diagrams illustrating a peak detection method in the ranging device according to the first embodiment.

FIG. 10 is a block diagram illustrating a schematic configuration of a ranging device according to a second embodiment.

FIG. 11 is a diagram illustrating a basic operation of the ranging device according to the second embodiment.

FIG. 12 is a block diagram illustrating a schematic configuration of a ranging device according to a third embodiment.

FIG. 13 is a flowchart illustrating the operation of the ranging device according to the third embodiment.

FIG. 14 is a block diagram illustrating a schematic configuration of a ranging device according to a fourth embodiment.

FIG. 15A and FIG. 15B are diagrams illustrating a configuration example of a movable object according to a fifth embodiment.

### DESCRIPTION OF THE EMBODIMENTS

Preferred embodiments of the present disclosure will now be described in detail in accordance with the accompanying drawings. Note that the following embodiments do not limit the present disclosure related to the claims, and not all combinations of features described in the embodiments are essential to the solution of the present disclosure.

### First Embodiment

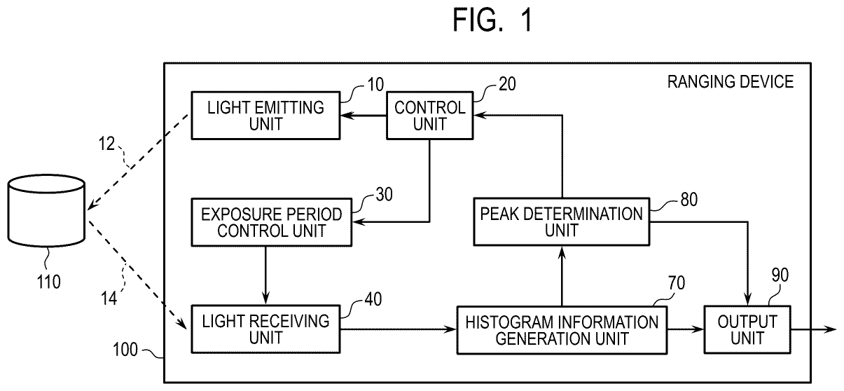

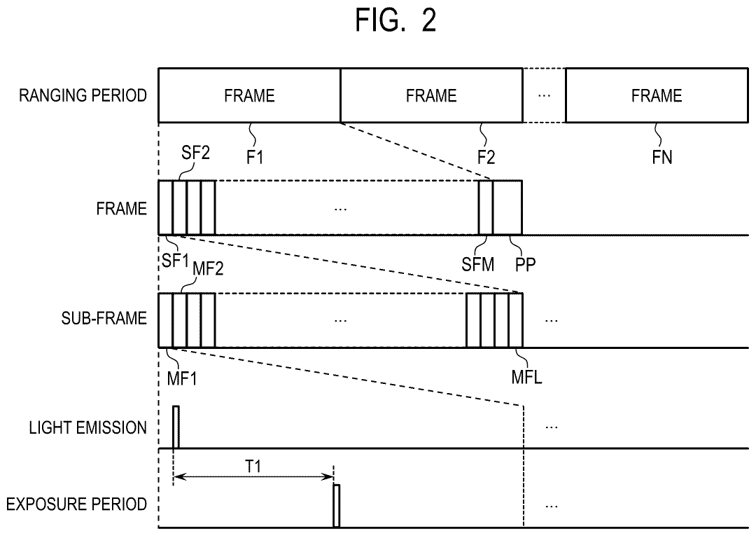

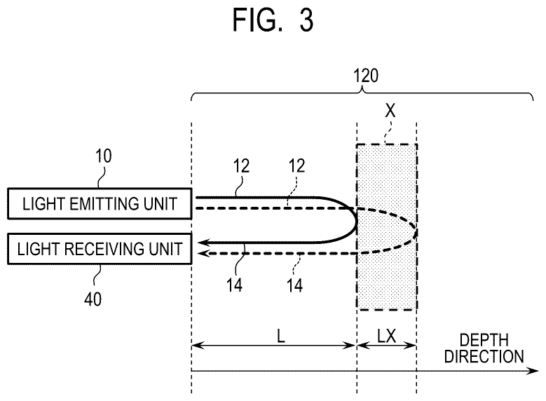

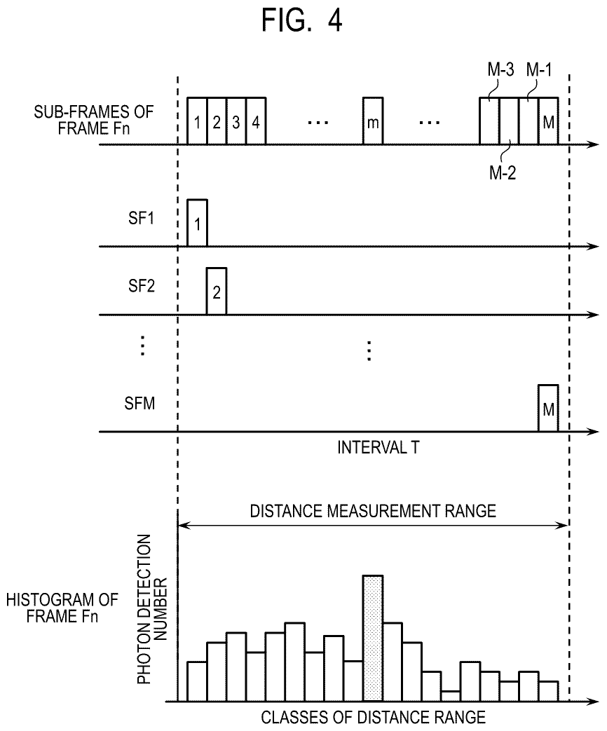

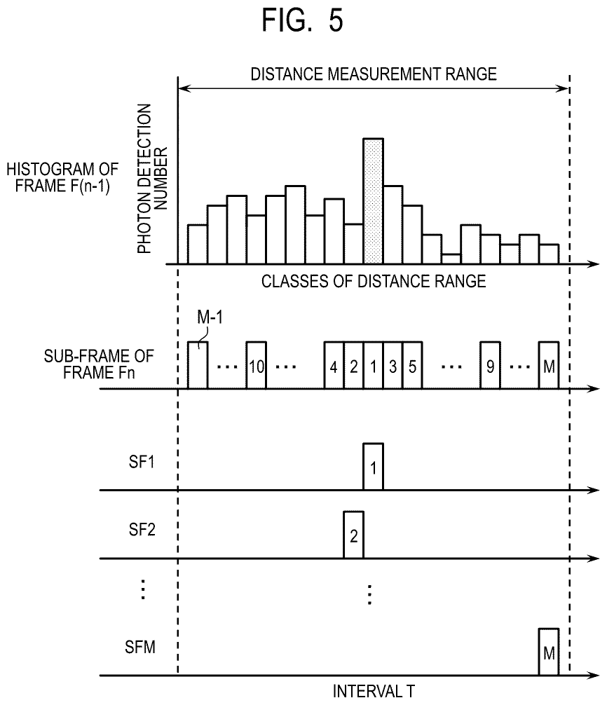

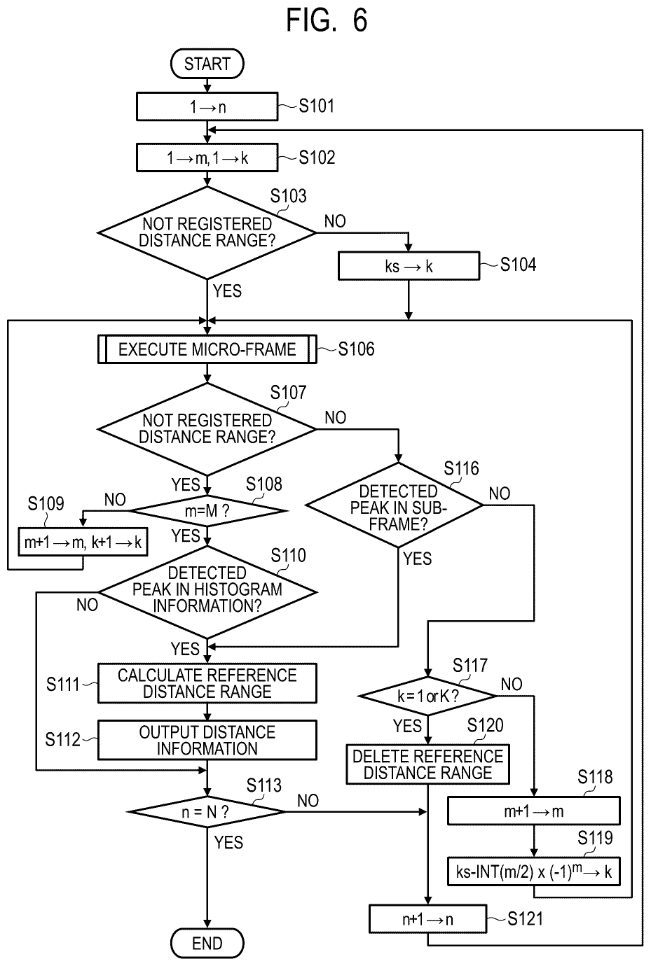

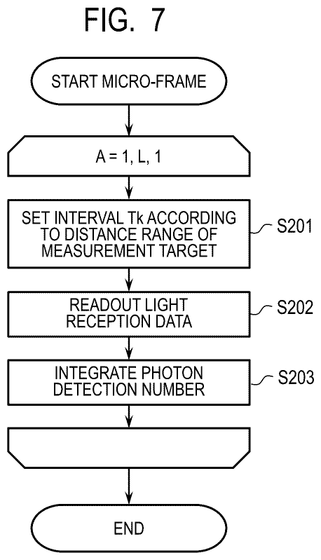

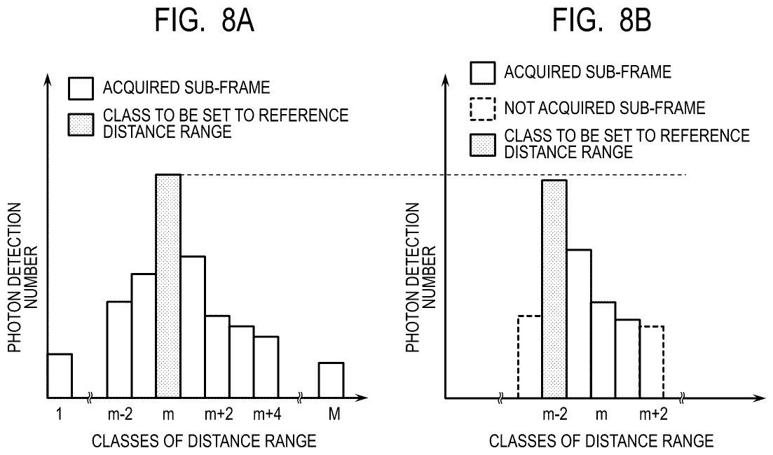

A ranging device and a ranging method according to a first embodiment of the present disclosure will be described with reference to FIG. 1 to FIG. 9B. FIG. 1 is a block diagram illustrating a schematic configuration of a ranging device according to the present embodiment. FIG. 2 is a timing chart illustrating a basic operation of the ranging device according to the present embodiment. FIG. 3 is a diagram explaining a method of acquiring distance information in the ranging device according to the present embodiment. FIG. 4 is a diagram explaining a first measurement mode in the ranging device according to the present embodiment. FIG. 5 is a diagram explaining a second measurement mode in the ranging device according to the present embodiment. FIG. 6 and FIG. 7 are flowcharts illustrating the operation of the ranging device according to the present embodiment. FIG. 8A to FIG. 9B are diagrams illustrating a peak detection method in the ranging device according to the present embodiment.

First, a schematic configuration of a ranging device according to the present embodiment will be described with reference to FIG. 1. As illustrated in, e.g., FIG. 1, a ranging device 100 according to the present embodiment may include a light emitting unit 10, a control unit 20, an exposure period control unit 30, a light receiving unit 40, a histogram information generation unit 70, a peak determination unit 80, and an output unit 90. The control unit 20 is connected to the light emitting unit 10 and the exposure period control unit 30. The exposure period control unit 30 is connected to the light receiving unit 40. The light receiving unit 40 is connected to the histogram information generation unit 70. The histogram information generation unit 70 is connected to the peak determination unit 80 and the output unit 90. The peak determination unit 80 is connected to the control unit 20 and the output unit 90.

The light emitting unit 10 includes a light emitting element (not illustrated), and has a role of emitting pulsed light (irradiation light 12) such as laser light emitted from the light emitting element to a measurement target region. As the light emitting element, for example, an element capable of high-speed modulation such as an LED (Light Emitting Diode) or an LD (Laser Diode) is preferable. The light-emitting element may be a VCSEL (Vertical Cavity Surface Emitting Laser) or a surface light-emitting element in which the VCSELs are arranged in an array. The light emitting unit 10 is preferably configured to emit light of a uniform amount to the measurement target region, and may further include an optical element, for example, a lens, for optically converting the light emitted from the light emitting element to irradiate the measurement target region.

The light receiving unit 40 includes a light receiving element (not illustrated) and has a function of detecting light incident from the measurement target region. The light incident on the light receiving unit 40 includes not only environmental light (external light such as sunlight) in the measurement target region but also light (reflected light 14) of the irradiation light 12 reflected by the ranging object 110 in the measurement target region. The light receiving element converts the incident light (optical signal) into an electrical signal (pulse signal), counts the generated pulse signal, and holds the counting result. The light receiving unit 40 may include a plurality of light receiving elements (pixels) arranged in a two-dimensional array. As the light receiving element, for example, a SPAD (Single Photon Avalanche Diode) sensor, a CMOS (Complementary Metal Oxide Semiconductor) sensor, or the like may be applied. The light receiving unit 40 may further include an optical element, for example, a lens, for efficiently guiding the reflected light 14 to the light receiving element 42.

The exposure period control unit 30 is a control circuit that outputs a control signal for controlling the drive timing of the light receiving unit 40. Specifically, the exposure period control unit 30 has a function of generating a control signal for controlling the timing of the start and end of the exposure period in the light receiving unit 40 according to the setting signal from the control unit 20, and outputting the generated control signal to the light receiving unit 40.

The control unit 20 is a control circuit that controls the general operation of the ranging device 100. FIG. 1 illustrates a portion related to control of the light emitting unit 10 and the light receiving unit 40 among the functions included in the control unit 20. That is, the control unit 20 outputs a control signal for controlling the light emission timing of the light emitting element to the light emitting unit 10. In addition, the control unit 20 outputs a setting signal for setting the exposure period in the light receiving unit 40 to the exposure period control unit 30.

The histogram information generation unit 70 accumulates information output from the light receiving unit 40, generates histogram information, and holds the generated histogram information. Here, the histogram information is information indicating a relationship between a plurality of classes (bins) determined according to the time from the emission of the pulsed light by the light emitting unit 10 to the detection by the light receiving unit 40 and the frequency indicating the number of times the pulsed light is detected in each class.

The peak determination unit 80 refers to the histogram information held by the histogram information generation unit 70, and calculates the distance to the ranging object 110 based on the time information corresponding to the class having the largest number of photons detected (frequency). In addition, the peak determination unit 80 determines an initial setting of the exposure period in the next frame, and outputs the initial setting to the control unit 20. In this specification, the term “frame” refers to a unit period from the start of distance measurement to the calculation of distance information. In one frame period, one distance information is output for each pixel (light receiving element) constituting the light receiving unit 40. The initial setting of the exposure period will be described later.

The output unit 90 has a function of outputting information held by the histogram information generation unit 70 and the peak determination unit 80 to the outside of the ranging device 100. Specifically, the output unit 90 outputs histogram information held by the histogram information generation unit 70 and information related to the distance to the ranging object 110 calculated by the peak determination unit 80.

FIG. 2 is a timing chart illustrating a basic operation of the ranging device according to the present embodiment.

During the ranging period in the ranging device according to the present embodiment, frames F of a predetermined length are sequentially performed a plurality of times. In FIG. 2, it is assumed that N-number of frames F including a frame F1, a frame F2, . . . , and a frame FN are performed during the ranging period.

In each frame F, a plurality of sub-frames SF and a peak determination period PP are executed. In FIG. 2, it is assumed that M-number of sub-frames SF including a sub-frame SF1, a sub-frame SF2, . . . , and a sub-frame SFM and a peak determination period PP are performed in one frame F. In this specification, the term “sub-frame” refers to a unit period of measurement performed for a predetermined distance range. The processing in the peak determination period PP will be described later.

In each sub-frame SF, a plurality of micro-frames MF are executed. In FIG. 2, it is assumed that L-number of micro-frames MF including a micro-frame MF1, a micro-frame MF2, . . . , and a micro-frame MFL are performed in one sub-frame SF.

In each micro-frame MF, one light emission of pulsed light by the light emitting unit 10 and an exposure period for detecting incident light in the light receiving unit 40 are executed.

In each micro-frame MF, an interval T from the timing of the start of the emission of the pulsed light to the timing of the start of the exposure period corresponds to a distance range determined for each sub-frame SF. For example, the interval Tis set to an interval T1 in the micro-frames MF1 to MFL of the sub-frame SF1, and the interval T is set to an interval T2 (not illustrated) different from the interval T1 in the micro-frames MF1 to MFL of the sub-frame SF2. A signal (light reception data) corresponding to incident light during the exposure period is output from the light receiving unit 40 for each micro-frame MF.

In this specification, the term “micro-frame” refers to a unit period in which the light receiving unit 40 outputs light reception data.

The distance range determined for each sub-frame SF will be described in more detail with reference to FIG. 3. Here, as illustrated in FIG. 3, it is assumed that a region X in which the distance from the light emitting unit 10 and the light receiving unit 40 is L and the depth in the depth direction is LX is assumed in the measurement target region 120 which is an irradiation region of the light (irradiation light 12) emitted from the light emitting unit 10. In this case, the optical path length of the reflected light 14 (solid line in the drawing) that is emitted from the light emitting unit 10, is reflected at the position of the surface of the region X on the side of the light emitting unit 10 and the light receiving unit 40, and reaches the light receiving unit 40 is 2L. On the other hand, the optical path length of the reflected light 14 (broken line in the drawing) that is emitted from the light emitting unit 10, is reflected at the position of the surface opposite to the light emitting unit 10 and the light receiving unit 40 in the region X, and reaches the light receiving unit 40 is 2 (L+LX). Due to the difference in the optical path length, a time difference occurs between the timing at which the light reflected at the position on the side of the light emitting unit 10 and the light receiving unit 40 in the region X reaches the light receiving unit 40 and the timing at which the light reflected at the position on the side opposite to the light emitting unit 10 and the light receiving unit 40 in the region X reaches the light receiving unit 40. This time difference may be expressed as 2LX/c, where c is the speed of light.

By setting the light receiving unit 40 to the exposure period only during the period corresponding to the time difference, it is possible to selectively acquire the information of the ranging object located in the region X in the measurement target region 120. That is, in the timing diagram of FIG. 2, the interval T from the timing of the start of the emission of the pulsed light to the timing of the start of the exposure period is set to a time corresponding to the distance of 2L, and the length of the exposure period is set to a time corresponding to the distance of 2LX. By setting the exposure period of the light receiving unit 40 in this manner, it is possible to acquire information on the ranging object located in the region X. Then, the measurement target region 120 is divided into a plurality of regions along the depth direction, and each of the micro-frames MF in which the exposure period is set corresponding to each region is performed, so that the information of the ranging object may be acquired over the entire measurement target region 120.

In each sub-frame SF, the micro-frame MF is performed a plurality of times (L times) while fixing the interval T from the timing of the start of emission of the pulsed light to the timing of the start of the exposure period. For example, in the sub-frame SF1 of FIG. 2, L-number of micro-frames MF1 to MFL in which the interval T is set to the interval T1 are performed. Then, the number of times the photons are detected by the light receiving unit 40 during the L-number of micro-frames MF1 to MFL is counted. By performing a plurality of sub-frames SF while changing the interval T, it is possible to acquire information (histogram information) in which a distance range (class) corresponding to each sub-frame SF and the number of photons detected (frequency) in the class are associated with each other.

The ranging device according to the present embodiment includes, as operation modes, a first measurement mode in which measurement is performed over the entire measurement target region while changing the distance range of the measurement target, and a second measurement mode in which measurement is performed preferentially in the vicinity of the distance range corresponding to the distance information acquired immediately before. In any of the measurement modes, the distance range is changed by controlling a period (exposure period) in which the light receiving unit 40 is activated by the exposure period control unit 30 in accordance with a setting signal from the control unit 20.

First, the first measurement mode will be described with reference to FIG. 4. The upper part of FIG. 4 illustrates a distance range set in each of the sub-frames SF1, . . . , SFm, . . . , and SFM constituting one frame Fn. The numbers 1, . . . , m, . . . , and M given to the respective blocks are the numbers of the sub-frames SF, and are also the order in which the respective sub-frames SF are executed. The horizontal axis represents an interval T, which indicates that the distance range of the sub-frame SF on the right side in the drawing is more distant from the ranging device. The middle part of FIG. 4 schematically illustrates that the sub-frame SF1, the sub-frame SF2, . . . , and the sub-frame SFM are executed in this order. The lower part of FIG. 4 illustrates an example of a histogram based on information acquired in the one frame Fn.

In the first measurement mode, as described above, measurement is performed over the entire distance measurement range while changing the distance range (exposure period) for each sub-frame SF. When the measurement target region is divided into M-number of distance ranges, for example, as illustrated in FIG. 4, measurement is sequentially performed from a distance range corresponding to the sub-frame SF1 having the shortest interval T to a distance range corresponding to the sub-frame SFM having the longest interval T. Note that the order in which the sub-frames SF1 to SFM are executed is not particularly limited.

When the photon is detected in the micro-frame MF, the light receiving unit 40 outputs a signal indicating that the photon is detected to the histogram information generation unit 70 for each pixel. The histogram information generation unit 70 counts the number of detected photons for each pixel in each sub-frame SF. That is, the information acquired in each sub-frame SF is a result of integrating the numbers of photons detected in the plurality of micro-frames MF belonging to the sub-frame SF, and indicates the sum of the numbers of photons detected in a predetermined distance range. The value thus counted is the number of photons detected in each sub-frame SF.

By performing measurement from the sub-frame SF1 to the sub-frame SFM, it is possible to acquire information in which the distance ranges (classes) corresponding to each of the sub-frames and the number of photons (frequency) detected in the respective distance ranges are associated with each other. The histogram information generation unit 70 holds the information thus acquired. In the present specification, this information is regarded as a histogram (see the lower part of FIG. 4) representing the relationship between the class and the frequency, and is referred to as histogram information.

In the last peak determination period PP of the frame Fn, the peak determination unit 80 extracts the distance range having the largest photon detection number from the histogram information held by the histogram information generation unit 70. For example, in the example of FIG. 4, since the photon detection number in the distance range corresponding to the sub-frame SFm is the largest, the distance to the ranging object 110 is calculated based on the interval Tm set in the sub-frame SFm.

Next, the second measurement mode will be described with reference to FIG. 5. The upper part of FIG. 5 illustrates an example of a histogram based on information acquired in a frame F(n−1) immediately before a certain frame Fn. The middle part of FIG. 5 illustrates a distance range set in each of the sub-frames SF1, . . . , SFm, . . . , and SFM constituting the frame Fn. The numbers 1, . . . , m, . . . , and M given to the respective blocks are the numbers of the sub-frames SF, and are also the order in which the respective sub-frames SF are executed. The horizontal axis represents an interval T, which indicates that the distance range of the sub-frame SF on the right side in the drawing is more distant from the ranging device. The lower part of FIG. 5 schematically illustrates that the sub-frame SF1, the sub-frame SF2, . . . , and the sub-frame SFM are executed in this order.

In the second measurement mode, as described above, measurement is preferentially performed in the vicinity of the distance range corresponding to the distance information acquired immediately before. The distance information acquired immediately before may be distance information calculated based on the histogram information of the immediately preceding frame held by the histogram information generation unit 70, or may be distance information acquired from the outside immediately before. In a case where different control is performed for each pixel or in a case where control is performed for each region, distance information may be acquired based on peaks of histogram information acquired for other pixels. When acquiring the distance information, the number of photons detected in the distance range around the peak may be further considered in addition to the number of photons detected in the peak distance range of the histogram information. When distance information is acquired from the outside, the distance information may be acquired using, for example, an ultrasonic sensor, a radar, a visible image camera, an infrared sensor, or another LiDAR system. In this case, the ranging device may further include a distance information acquisition unit for acquiring distance information from the outside.

Here, as the distance information acquired immediately before, the distance information calculated based on the histogram information of the immediately preceding frame F(n−1) is assumed. When the frame Fn in the measurement example of FIG. 4 is assumed as the immediately preceding frame F(n−1), the distance range corresponding to the sub-frame SFm of FIG. 4 is the distance information calculated immediately before. In this case, in the second measurement mode, the distance range corresponding to the sub-frame SFm in FIG. 4 is set as a reference distance range. Then, the distance range set as the reference distance range is set to the sub-frame SF to be executed first, and the unmeasured distance range closer to the reference distance range is preferentially set to the sub-frame SF to be executed next.

In the case of the example of FIG. 5, the exposure period control unit 30 first sets the distance range corresponding to the sub-frame SFm of FIG. 4 to the sub-frame SF1 to be executed first, and executes the sub-frame SF1. The peak determination unit 80 refers to the information acquired by the measurement of the sub-frame SF1, and determines whether or not the information has a peak equivalent to the peak acquired in the immediately preceding frame F. Details of the peak determination method will be described later.

When a peak does not exist in the sub-frame SF1, the exposure period control unit 30 sets the distance range having the next higher priority than the reference distance range as the sub-frame SF2 to be executed next, and executes the sub-frame SF2. In the example of FIG. 5, a distance range adjacent to the reference distance range and located closer to the ranging device 100 than the reference distance range is set to the sub-frame SF2. The peak determination unit 80 refers to the information acquired by the measurement of the sub-frame SF2, and determines whether or not the information has a peak equivalent to the peak acquired in the immediately preceding frame F.

When there is no peak in the sub-frame SF2, the exposure period control unit 30 sets the distance range having the next higher priority than the distance range set in the sub-frame SF2 as the sub-frame SF3 to be executed next, and executes the sub-frame SF3. In the example of FIG. 5, a distance range adjacent to the reference distance range and located on the side opposite to the ranging device 100 with respect to the reference distance range is set as the sub-frame SF3. The peak determination unit 80 refers to the information acquired by the measurement of the sub-frame SF3, and determines whether or not the information has a peak equivalent to the peak acquired in the immediately preceding frame F. Thereafter, until a peak is detected in the acquired information, the sub-frame SF is set in order from the distance range with the highest priority, and the sub-frame SF is executed.

When the acquired information has a peak equivalent to the peak acquired in the immediately preceding frame F(n−1), the acquisition of the subsequent sub-frame SF is stopped, and the distance range corresponding to the sub-frame SF in which the peak is detected is set as a new reference distance range.

Since the time from the immediately preceding frame F(n−1) to the frame Fn is short, it is expected that the distance range in which the peak is detected in the successive frames F is short if the ranging object is the same. Therefore, according to the second measurement mode, it is possible to reduce the number of sub-frames SF to be performed in one frame F and to acquire the distance information of the ranging object at high speed.

Next, a specific operation of the ranging device according to the present embodiment will be described with reference to FIG. 6 and FIG. 7. The flowcharts of FIG. 6 and FIG. 7 illustrate an operation example in which, when a peak exists in histogram information acquired in the immediately preceding frame F(n−1), a reference distance range is calculated from the peak, and measurement is preferentially performed from the vicinity of the calculated reference distance range. In this operation example, the acquisition of the sub-frame SF subsequent to the frame Fn is interrupted at the stage where the position of the ranging object can be specified, and the operation proceeds to the distance measurement operation of the next frame F(n+1).

First, in step S101, a variable n representing the number of the frame F is set to 1. Although it is assumed here that a predetermined number (N) of frames are continuously executed as the distance measurement operation, the number of frames to be executed may not be determined in advance, and the distance measurement operation may be stopped in response to an external signal or the like, for example. In this case, step S101 is unnecessary.

Next, in step S102, a variable m indicating the order of the sub-frames SF and a variable k indicating the number of the distance range of the measurement target are set to 1. Here, the maximum number of sub-frames executed during one frame is assumed to be M. The number k of the distance range represents, for example, the distance range corresponding to the class of the histogram information by serial numbers of 1, 2, 3, . . . , K−2, K−1, and K from the side closer to the ranging device. K represents a number of a distance range farthest from the ranging device among the distance ranges included in the distance measuring range.

Next, in step S103, it is determined whether or not the reference distance range is set in the peak determination unit 80. As a result of the determination, when the reference distance range is not set in the peak determination unit 80 (“YES” in step S103), the process proceeds to step S106. As a result of the determination, when the reference distance range is set in the peak determination unit 80 (“NO” in step S103), the process proceeds to step S104, and the variable k is set to the number ks of the reference distance range. As a result, the measurement mode shifts to the second measurement mode. After step S104, the process proceeds to step S106.

Next, in step S106, the micro-frames MF are executed. In step S106, a series of processing from step S201 to step S203 illustrated in FIG. 7 is assumed to be one micro-frame MF, and is repeatedly executed L times as illustrated in FIG. 2. A variable A in FIG. 7 is a variable indicating the number of times of execution of the micro-frame MF. “A=1, L, 1” indicates that the processing is repeatedly executed from the micro-frame MF1 to the micro-frame MFL while increasing A by 1.

The measurement mode in the micro-frame MF is determined according to whether or not the reference distance range is set in the peak determination unit 80. That is, the first measurement mode is executed when the reference distance range is not set in the peak determination unit 80, and the second measurement mode is executed when the reference distance range is set in the peak determination unit 80.

In step S201, the control unit 20 controls the light emitting unit 10 and the exposure period control unit 30, sets the interval T from the timing of the start of the emission of the pulsed light by the light emitting unit 10 to the timing of the start of the exposure period to the interval Tk, and performs measurement. The interval Tk is set to, e.g., the interval T1 corresponding to the distance range closest to the ranging device in the case of the micro-frame MF1 in the first measurement mode, and is set to, e.g., the interval Tks corresponding to the reference distance range in the case of the micro-frame MF1 in the second measurement mode. When photons are detected during the exposure period, each pixel constituting the light receiving unit 40 generates light reception data representing the number of photons detected, and holds the light reception data therein.

In step S202, the histogram information generation unit 70 performs readout scanning on the plurality of pixels constituting the light receiving unit 40, and sequentially reads out the light reception data held by the pixels in a predetermined region.

In step S203, the histogram information generation unit 70 integrates the number of photons indicated by the readout light reception data for each pixel.

By performing the micro-frame MF L times in this manner and integrating the photon detection number for each pixel, the photon detection number (frequency) in the distance range (class) corresponding to the interval Tk may be acquired as the data of the sub-frame SFm.

Next, in step S107, it is determined whether or not the reference distance range is set in the peak determination unit 80. As a result of the determination, when the reference distance range is not set in the peak determination unit 80 (“YES” in step S107), the process proceeds to step S108. As a result of the determination, when the reference distance range is set in the peak determination unit 80 (“NO” in step S107), the process proceeds to step S116.

In step S108, it is determined whether or not the sub-frame SFm being executed is the last sub-frame SFM constituting the frame Fn. As a result of the determination, when the sub-frame SFm being executed is the last sub-frame SFM constituting the frame F(m =M, “YES” in step S108), the process proceeds to step S110. As a result of the determination, when the sub-frame SFm being executed is not the last sub-frame SFM constituting the frame Fn (m≠M, “NO” in step S108), the process proceeds to step S109. In step S109, the variable m representing the number of the sub-frame SF and the variable k representing the number of the distance range are incremented by 1. After step S109, the process returns to step S106, and the micro-frame MF of the next sub-frame SF(m+1) is executed.

When the reference distance range is not set in the peak determination unit 80, the above-described series of processing from step S106 to step S109 is repeatedly executed M times while sequentially changing the distance range of the measurement target. That is, the first measurement mode is executed, and histogram information over the entire distance measurement range is acquired.

In step S110, the peak determination unit 80 determines whether a peak is detected in the histogram information acquired in the first ranging mode. As a result of the determination, when the peak is not detected (“NO” in step S110), the process proceeds to step S113. As a result of the determination, when the peak is detected (“YES” in step S110), the process proceeds to step S111. Details of the peak determination method will be described later.

In step S111, the peak determination unit 80 sets the number of the distance range in which the peak is detected as the number ks of the reference distance range, and calculates distance information to the ranging object based on the distance range in which the peak is detected.

In step S112, the output unit 108 outputs the distance information calculated by the peak determination unit 107 to the outside.

In step S113, it is determined whether or not the currently executed frame Fn is the last frame FN. As a result of the determination, when the currently executed frame Fn is the last frame FN (n=N, “YES” in step S113), a series of ranging processing ends. As a result of the determination, when the currently executed frame Fn is not the last frame FN (n≠N, “NO” in step S113), the process proceeds to step S121, and the variable n indicating the number of the frame F is incremented by 1. After step S121, the process returns to step S102 to execute the next frame F(n+1).

In step S116, the peak determination unit 80 determines whether a peak is detected in the sub-frame SFm. As a result of the determination, when the peak is detected (“YES” in step S116), the control unit 20 stops the processing of the sub-frame SF subsequent to the frame Fn, and the process proceeds to step S111. When the peak is not detected (“NO” in step S116), the process proceeds to step S117. Details of the peak determination method will be described later.

In step S117, it is determined whether or not the distance range of the measurement target is a distance range closest to the ranging device (k=1) or a distance range farthest from the ranging device in the distance measuring range (k=K).

As a result of the determination in step S117, when the variable k is not 1 or K (“NO” in step S117), the process proceeds to step S118. In step S118, the variable m representing the number of the sub-frame SF is incremented by 1. In step S119, the distance range of the measurement target in the next sub-frame SF(m+1) is selected from unmeasured distance ranges closer to the reference distance range. For example, the number k of the distance range to be measured in the sub-frame SFm may be set to (ks−INT(m/2)×(−1)^{m}), where ks is the number of the reference distance range and m is the number of the sub-frame SF. Note that INT is a function that truncates the number below the decimal points. By setting the number k of the distance range to be measured in this way, the distance ranges in the sub-frames SF1, SF2, SF3, SF4, SF5, SF6, . . . are assigned in the order of the distance ranges ks, ks−1, ks+1, ks−2, ks+2, ks−3, . . . . As a result, it is possible to preferentially assign to the sub-frames SF in order from the unmeasured distance range closer to the reference distance range. After step S119, the process returns to step S106, and the next sub-frame SF(m+1) of the frame Fn is executed.

As a result of the determination in step S117, when the variable k is 1 or K (“YES” in step S117), the process proceeds to step S120, and the registered reference distance range is deleted. That is, the fact that the variable k has reached 1 or K means that no peak has been detected in the second measurement mode, and the reference distance range registered for executing the next frame F(n+1) in the first measurement mode is deleted. After step S120, the process proceeds to step S121, and the variable n representing the number of the frame F is incremented by 1. After step S121, the process returns to step S102 to execute the next frame F(n+1).

Next, a peak detection method in steps S110 and S116 will be described with reference to FIG. 8A to FIG. 9B. FIG. 8A and FIG. 9A illustrate examples of histograms in the frame Fn measured in the first measurement mode. FIG. 8B illustrates an example of a histogram in the next frame F(n+1) in which the reference distance range is set based on the histogram of FIG. 8A and measurement is performed in the second measurement mode. FIG. 9B illustrates an example of a histogram in the next frame F(n+1) in which the reference distance range is set based on the histogram of FIG. 9A and measurement is performed in the second measurement mode.

FIG. 8A and FIG. 8B illustrate an example in which only one clear peak is detected in the histogram of the frame Fn measured in the first measurement mode. In the frame Fn, in the first measurement mode, the measurement of the sub-frames SF1 to SFM corresponding to the entire distance measurement range is performed while sequentially changing the distance range of the measurement target in the direction away from the side of the ranging device (see FIG. 8A). In the case of this frame Fn, since the peak of the photon detection number exists in the sub-frame SFm, the number m of the class of the distance range corresponding to the sub-frame SFm is set as the number ks of the reference distance range.

As in this case, when only one clear peak is detected in the histogram acquired by measuring the entire distance measurement range, the distance range corresponding to the sub-frame SFm in which the peak is detected is set as the reference distance range in the next frame F(n+1).

In the frame F(n+1), in the second measurement mode, unmeasured distance ranges are sequentially selected in order of proximity with respect to the reference distance range set in the frame Fn with the reference distance range as a center, and the measurement is continued until a peak is detected. In the example of FIG. 8B, the distance ranges corresponding to the classes m, m−1, m+1, m−2, . . . are sequentially selected, and the sub-frame SF is executed. When a peak corresponding to the peak detected in the frame Fn is detected, the execution of the subsequent frame is stopped.

For example, if a peak corresponding to the peak of the frame Fn is detected in the class (m−2) of the frame F(n+1), the sub-frames SF corresponding to the class (m+2) and the subsequent classes are not executed, and the process is shifted to the frame F(n+2).

The peak corresponding to the peak of the frame Fn may be detected by, for example, comparing the photon detection number in the class of the frame Fn set as the reference distance range with the photon detection number in the class of the distance range of interest. For example, the photon detection number in the class of the frame Fn set as the reference distance range is multiplied by a predetermined error rate and held in the memory as a value including the error range. Then, the photon detection number detected in the class acquired in the frame F(n+1) is compared with the value held in the memory. When the photon detection number in the class acquired in the frame F(n+1) is larger than the value held in the memory, the photon detection number may be determined to be a peak. Alternatively, a threshold value for determining the magnitude of the peak may be set in advance, and the determination may be performed by comparing the magnitude of the peak acquired in the frame F(n+1) with the threshold value. The method of detecting the peak corresponding to the peak of the frame Fn is not limited thereto as long as the method can specify the size of the peak.

FIG. 9A and FIG. 9B illustrate an example in which a plurality of classes indicating the photon detection number equivalent to the maximum photon detection number are detected in the histogram of the frame Fn measured in the first measurement mode. Also in the present measurement example, as in the example of FIG. 8A and FIG. 8B, in the frame Fn, the measurement of the sub-frames SF1 to SFM corresponding to the entire distance measurement range is performed while sequentially changing the distance range of the measurement target in the direction away from the side of the ranging device in the first measurement mode (see FIG. 9A). When a plurality of classes indicating the photon detection number equivalent to the maximum photon detection number are detected, the reference distance range may be set according to the purpose of use of the ranging device. For example, in the case where the ranging device is applied to an on-vehicle sensor, from the viewpoint of improving the detection sensitivity of a nearer ranging object, it is possible to set, as the reference distance range, a class having the closest distance from the ranging device among the plurality of classes indicating the photon detection number equivalent to the maximum photon detection number. In the example of FIG. 9A, the distance range corresponding to the class m may be set as the reference distance range.

In the frame F(n+1), in the second measurement mode, unmeasured distance ranges are sequentially selected in order of proximity with respect to the reference distance range set in the frame Fn with the reference distance range as a center, and the measurement is continued until a peak is detected. In the example of FIG. 9B, the distance ranges corresponding to the classes m, m−1, m+1, m−2, . . . are sequentially selected, and the sub-frame SF is executed. When a peak corresponding to the peak detected in the frame Fn is detected, the execution of the subsequent frame is stopped.

For example, if the peak corresponding to the peak of the frame Fn is detected in the class (m+1) of the frame F(n+1), the sub-frames SF corresponding to the class (m−2) and the subsequent classes are not executed, and the process shifts to the frame F(n+2). The peak detection method may be similar to that of FIG. 8B.

When a plurality of classes indicating the photon detection number equivalent to the maximum photon detection number, the class to be selected as the reference distance range does not necessarily need to be the class having the closest distance from the ranging device. For example, among the plurality of classes indicating the photon detection number equivalent to the maximum photon detection number, the class having the farthest distance from the ranging device may be set, or the class may be set to an intermediate class among the plurality of classes indicating the photon detection number equivalent to the maximum photon detection number. Alternatively, a class to be the reference distance range may be selected by using an integrated value of the photon detection number in the class of interest and the photon detection numbers in the surrounding classes. The class in which the photon detection number in the histogram information is the maximum may not necessarily coincide with the class corresponding to the distance information to the distance measurement object or the reference distance range calculated by the peak determination unit 80.

As described above, in the present embodiment, when a peak is detected in the histogram information in the measurement in the first measurement mode in a certain frame, the measurement is performed in the second measurement mode in the next frame, and the distance range close to the distance range in which the peak is detected is preferentially measured. When a peak corresponding to the peak of the previous frame is detected, the measurement of the frame is stopped. Therefore, as compared with the case where the presence or absence of a peak is determined after the histogram information over the entire distance measurement range is acquired in all the frames, the determination of the distance to the ranging object may be performed at high speed. In addition, the frame rate may be improved by stopping the acquisition of the sub-frames after the distance determination and shifting to the next frame.

In the above-described embodiment, the micro-frame MF is executed L times in each sub-frame SF, but when the reflected light 14 is detected in a certain micro-frame MF, the micro-frames MF subsequent to the sub-frame SF may not be acquired. With this configuration, it is possible to reduce power consumption while maintaining a constant frame rate.

As described above, according to the present embodiment, in the ranging device and the ranging method in which the distance information along the depth direction of the distance measuring range is acquired by performing the measurement while sequentially shifting the exposure period, it is possible to reduce the time required to acquire the distance information.

### Second Embodiment

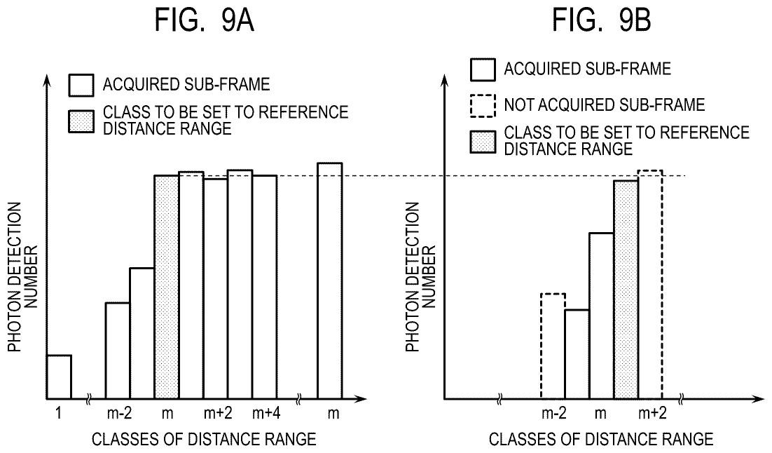

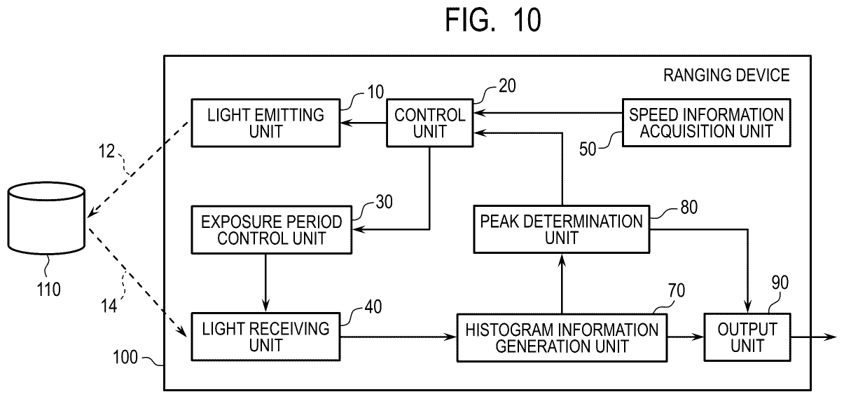

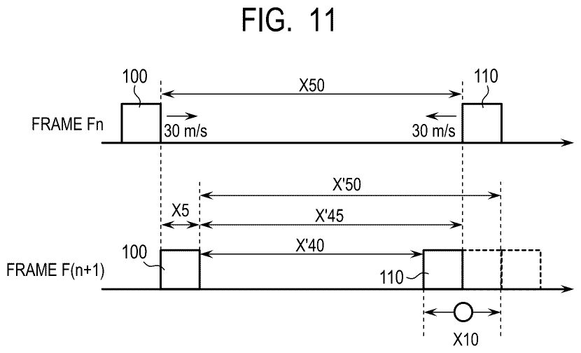

A ranging device and a ranging method according to a second embodiment of the present disclosure will be described with reference to FIG. 10 and FIG. 11. The same components as those of the ranging device according to the first embodiment are denoted by the same reference numerals, and description thereof will be omitted or simplified. FIG. 10 is a block diagram illustrating a schematic configuration of a ranging device according to the present embodiment. FIG. 11 is a diagram schematically illustrating a positional relationship between the ranging device and the ranging object when the ranging device or the ranging object is moving.

In the present embodiment, a configuration of a ranging device and a ranging method suitable for calculating a distance to a ranging object when the ranging device or the ranging object is moving will be described.

First, a schematic configuration of a ranging device according to the present embodiment will be described with reference to FIG. 10.

As illustrated in FIG. 10, the ranging device 100 according to the present embodiment is the same as the ranging device according to the first embodiment except that a speed information acquisition unit 50 is further included. The speed information acquisition unit 50 is connected to the control unit 20. The speed information acquisition unit 50 is a functional block having a function of measuring a relative moving speed between the ranging device and the ranging object and supplying the measured speed information to the control unit 20. The speed information acquisition unit 50 itself may have a function of measuring the moving speed of the ranging device 100, or may be configured to acquire speed information acquired by a speed measurement device different from the ranging device 100.

FIG. 11 is a diagram schematically illustrating a positional relationship between the ranging device 100 and a ranging object 110, assuming an on-vehicle sensor as an application example of the ranging device 100. In FIG. 11, it is assumed that the ranging device 100 and the ranging object 110 are moving at the same speed (30 m/s) in a direction approaching each other.

In FIG. 11, X5, X10, and X50 represent distances in units of the distance ranges used for classes of the histogram information. For example, in the frame Fn, the ranging device 100 and the ranging object 110 are separated from each other by a distance X50, which indicates that the ranging device 100 and the ranging object 110 are separated from each other by a distance corresponding to a 50th distance range (k=50) from the side of the ranging device 100. In other words, when histogram information of the frame Fn is acquired, a clear peak is detected in the sub-frame SF corresponding to the 50th distance range (k=50).

When the ranging device 100 is driven at a predetermined frame rate, it is assumed that the distance between the ranging device 100 and the ranging object 110 is close to the distance X′40 in the frame F(n+1) next to the frame Fn. The distance X′ represents a distance based on the position of the ranging device 100 after the transition to the frame F(n+1). A numerical value after X′ represents a distance in units of the distance ranges used for classes of the histogram information, as in the case of the distance X.

In FIG. 11, a circle (○) indicates an exposure start position (reference distance range) obtained by correcting the exposure start position (reference distance range) in the next frame F(n+1) calculated from the histogram information of the frame Fn using the speed information acquired by the speed information acquisition unit 50. By correcting the reference distance range obtained from the measurement of the frame Fn using the speed information of the ranging device 100 acquired by the speed information acquisition unit 50, it is possible to start the measurement from a position closer to the ranging object 110. Hereinafter, this will be described with reference to examples.

When the speed information is not used, the exposure start position (reference distance range) set for the frame F(n+1) is a position separated by a distance X50 from the position of the ranging device 100 in the frame F(n+1), that is, a position at a distance X′50 in FIG. 11. On the other hand, when the speed information of the speed information acquisition unit 50 is used, it can be known that the position of the ranging device 100 in the frame F(n+1) moves by the distance X5 in the direction of the ranging object 110. Thus, the exposure start position (reference distance range) set for the frame F(n+1) can be corrected to the position of the distance X′45 from the position of the ranging device 100 in the frame F(n+1). Then, since the exposure start position approaches the distance range in which the peak is expected to be detected, it is possible to reduce sub-frames to be performed in the second measurement mode, and it is possible to improve the frame rate.

Although the exposure start position (reference distance range) is corrected using the speed information of the ranging device 100 in the present embodiment, the exposure start position (reference distance range) may be corrected using the speed information of the ranging object 110. For example, it is possible to correct the information of the reference exposure range calculated from the peak of the histogram information using the speed information of the ranging object 110 acquired using another measurement device, and set the reference distance range in which the measurement is started in the next frame.

Further, by correcting the exposure start position (reference distance range) of the next frame using the speed information of the ranging device 100 and the speed information of the ranging object 110, it is possible to further enhance the effect of improving the frame rate. That is, when the exposure start position (reference distance range) is set using the information of the reference distance range and the speed information of the ranging device 100, the exposure start position is a position at a distance X′45 from the ranging device 100. On the other hand, by further considering the speed information of the ranging object 110, it is possible to set the exposure start position to the position of the distance X′40 from the ranging device 100. If the moving direction of the ranging object 110 is opposite, the exposure start position can be set to a position at a distance X′50 from the ranging device 100.

As described above, according to the present embodiment, in the ranging device and the ranging method in which the distance information along the depth direction of the distance measuring range is acquired by performing the measurement while sequentially shifting the exposure period, it is possible to reduce the time required to acquire the distance information.

### Third Embodiment

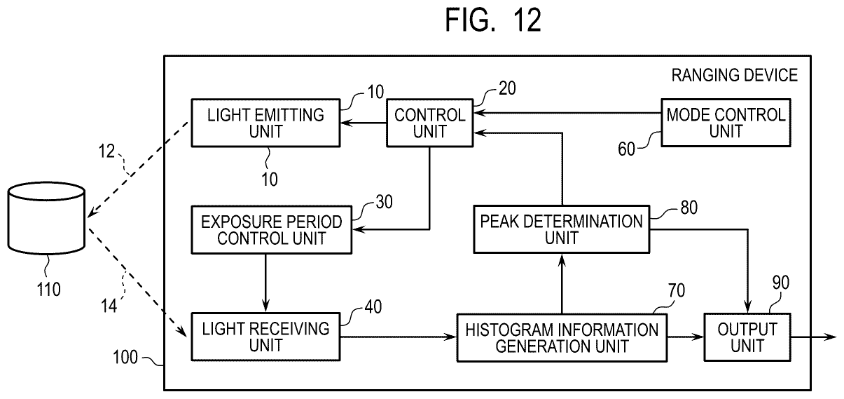

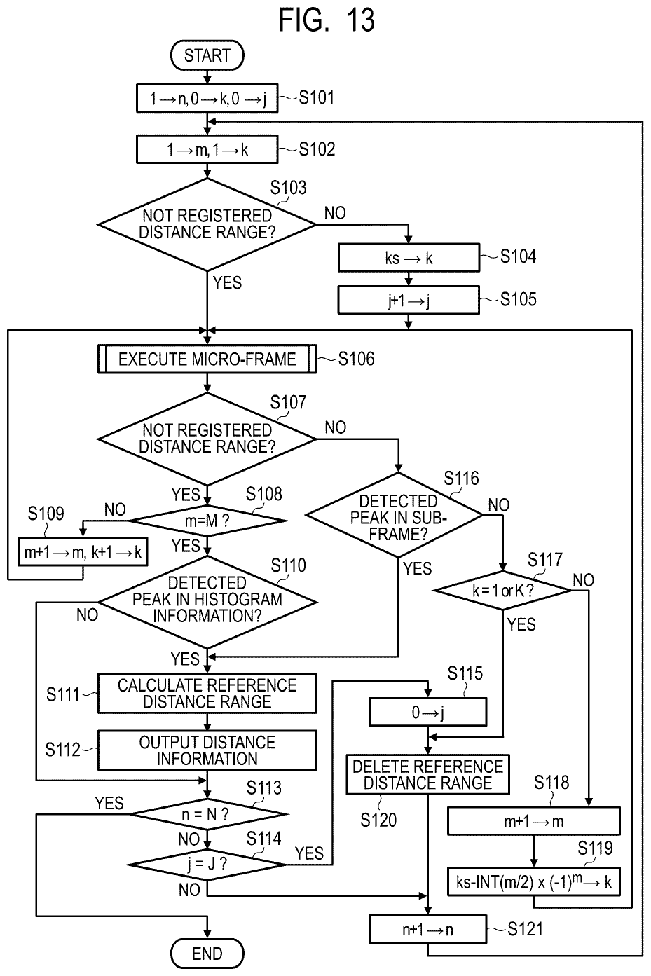

A ranging device and a ranging method according to a third embodiment of the present disclosure will be described with reference to FIG. 12 and FIG. 13. The same components as those of the ranging device according to the first or second embodiment are denoted by the same reference numerals, and description thereof will be omitted or simplified. FIG. 12 is a block diagram illustrating a schematic configuration of a ranging device according to the present embodiment. FIG. 13 is a flowchart illustrating the operation of the ranging device according to the present embodiment.

First, a schematic configuration of a ranging device according to the present embodiment will be described with reference to FIG. 12.

As illustrated in FIG. 12, the ranging device 100 according to the present embodiment is the same as the ranging device according to the first embodiment except that a mode control unit 60 is further included. The mode control unit 60 is connected to the control unit 20. The mode control unit 60 is a functional block having a function of generating a control signal for switching between the first measurement mode and the second measurement mode and supplying the generated control signal to the control unit 20. For example, the mode control unit 60 may include a binary counter that counts the number of frames in which measurement is performed, and may be configured to execute the first measurement mode once every four frames, for example. Alternatively, the mode control unit 60 may include a binary counter that counts the number of frames performed from the setting of the reference distance range, and may be configured to execute the first measurement mode when the measurement in the second measurement mode is continuously performed for a predetermined number of frames. In the configuration example illustrated in FIG. 12, the mode control unit 60 is a part of the components of the ranging device 100, but a mode control unit may be prepared as a separate device from the ranging device 100, and the mode control unit may switch the measurement mode.

Next, a specific operation of the ranging device according to the present embodiment will be described with reference to FIG. 13.

The flowchart of FIG. 13 is the same as the flowchart of the first embodiment illustrated in FIG. 6 except that steps S105, S114, and S115 are further included. The variable j is a variable for counting the number of frames F consecutively performed F in the second measurement mode. J is a value defined in advance as an upper limit value of the number of frames in which continuous measurement in the second measurement mode is allowed.

When the measurement is started, the variable j is initialized to 0 in step S101. When the reference distance range is registered in the peak determination unit 80, the mode shifts to the second measurement mode, and the value of the variable j is incremented by 1 in step S105 before the start of the sub-frame SF of the next frame F. When the processing of the frame F ends, it is determined in step S114 whether or not the value of the variable j has reached J. As a result of the determination, when the variable j has not reached J (“NO” in step S114), the process proceeds to step S121. As a result of the determination, when the variable j has reached J (“YES” in step S114), the process proceeds to step S115, and the variable j is initialized to 0. After step S115, the process proceeds to step S120, and the reference distance range registered in the peak determination unit 80 is deleted. Accordingly, the measurement mode of the frame to be executed next becomes the first measurement mode.

By performing the distance measurement operation in this manner, the number of times the frame F performed in the second measurement mode continues is J times at the maximum. Therefore, even if another ranging object is generated in a distance range not included in the distance measurement range of the second measurement mode in which the distance measurement range of the first measurement mode is included, the ranging object can be detected.

As described above, according to the present embodiment, in the ranging device and the ranging method in which the distance information along the depth direction of the distance measuring range is acquired by performing the measurement while sequentially shifting the exposure period, it is possible to reduce the time required to acquire the distance information.

### Fourth Embodiment

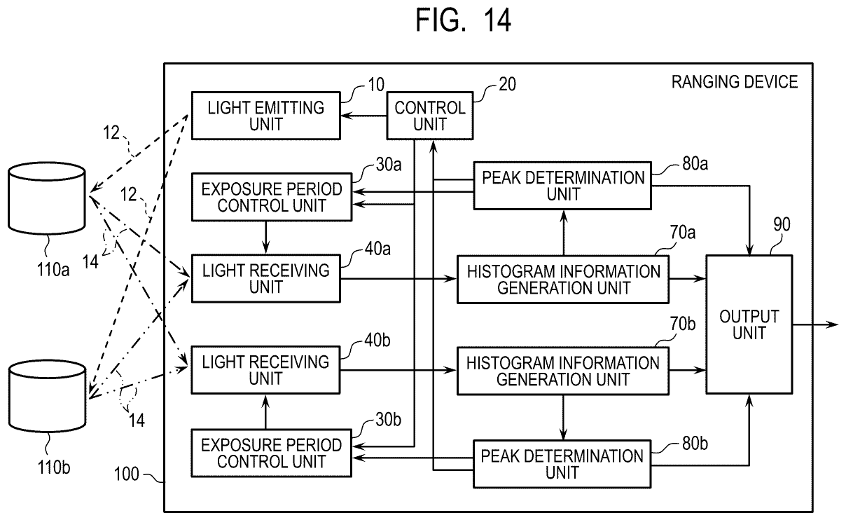

A ranging device and a ranging method according to a fourth embodiment of the present disclosure will be described with reference to FIG. 14. The same components as those of the ranging device according to the first to third embodiments are denoted by the same reference numerals, and description thereof will be omitted or simplified. FIG. 14 is a block diagram illustrating a schematic configuration of a ranging device according to the present embodiment.

In the ranging device 100 according to the present embodiment, as illustrated in FIG. 14, the pixel region of the light receiving unit 40 is divided into a plurality of regions (light receiving units 40a and 40b). An exposure period control unit 30, a histogram information generation unit 70, and a peak determination unit 80 are provided corresponding to each of the plurality of regions of the light receiving unit 40. That is, the ranging device 100 according to the present embodiment includes a light receiving unit 40a, and an exposure period control unit 30a, a histogram information generation unit 70a and a peak determination unit 80a corresponding thereto. The ranging device 100 according to the present embodiment also includes a light receiving unit 40b, and an exposure period control unit 30b, a histogram information generation unit 70b and a peak determination unit 80b corresponding thereto.

The control unit 20 transmits to each of the exposure period control units 30a and 30b a setting signal for driving the corresponding light receiving units 40a and 40b. The operation of each of the other components is the same as that of the first embodiment except that the regions (light receiving portions 40a and 40b) of the target light receiving portion are different, and thus the description thereof is omitted here. The ranging device 100 creates histogram information for each of the light receiving units 40a and 40b, and calculates a distance to the ranging object 110 and a reference distance range.

By independently controlling the exposure period for each of the divided light receiving units 40a and 40b, the ranging object 110 can be detected for each of the light receiving units 40a and 40b. Even if a plurality of ranging objects 110a and 110b exist in the measurement target region as illustrated in FIG. 14, it is possible to change the exposure condition for each of the light receiving units 40a and 40b. Therefore, it is possible to calculate the distances to the ranging objects 110a and 110b more accurately as compared with a case where the distance measurement is performed using the same exposure condition for the entire pixel region of the light receiving unit 40.

In the present embodiment, although an example in which the exposure period control unit 30, the histogram information generation unit 70, and the peak determination unit 80 are provided in the same number as the number of divisions of the light receiving unit 40 has been described, these numbers do not necessarily have to be the same. That is, as long as each of the plurality of divided regions of the light receiving unit 40 can be independently controlled, the number of the exposure period control unit 30, the histogram information generation unit 70, and the peak determination unit 80 is not necessarily the same as the number of the divided regions of the light receiving unit 40. The number of divisions of the light receiving unit 40 is not necessarily two, and may be three or more.

As described above, according to the present embodiment, in the ranging device and the ranging method in which the distance information along the depth direction of the distance measuring range is acquired by performing the measurement while sequentially shifting the exposure period, it is possible to reduce the time required to acquire the distance information.

### Fifth Embodiment

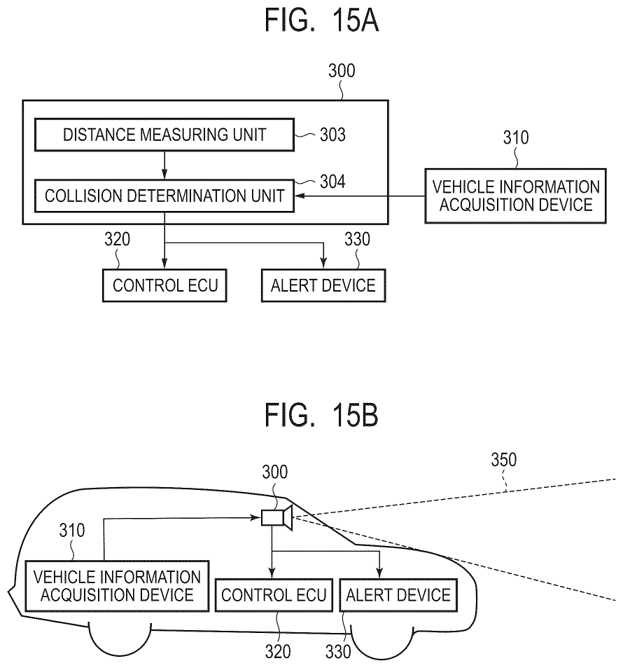

A movable object according to a fifth embodiment of the present disclosure will be described with reference to FIG. 15A and FIG. 15B. FIG. 15A and FIG. 15B are diagrams illustrating a configuration example of a movable object according to the present embodiment.

FIG. 15A illustrates a configuration example of equipment mounted on a vehicle as an on-vehicle camera. The equipment 300 includes a distance measuring unit 303 that measures a distance to a ranging object, and a collision determination unit 304 that determines whether or not there is a possibility of collision based on the distance measured by the distance measuring unit 303. The distance measuring unit 303 is configured by the ranging device 100 described in any of the first to fourth embodiments. Here, the distance measuring unit 303 is an example of a distance information acquisition unit that acquires distance information to the ranging object. That is, the distance information is information related to the distance to the ranging object or the like.

The equipment 300 is connected to the vehicle information acquisition device 310, and may acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the equipment 300. The equipment 300 is also connected to an alert device 330 that issues an alert to the driver based on the determination result of the collision determination unit 304. For example, when the determination result of the collision determination unit 304 indicates that the possibility of collision is high, the control ECU 320 performs vehicle control to avoid collision and reduce damage by, for example, applying a brake, returning an accelerator, or suppressing engine output. The alert device 330 gives a warning to the user by sounding a warning such as a sound, displaying warning information on a screen of a car navigation system or the like, giving vibration to a seat belt or a steering wheel, or the like. These devices of the equipment 300 function as a movable object control unit that controls the operation of controlling the vehicle as described above.

In the present embodiment, the distance to the surroundings of the vehicle, for example, the front or the rear is measured by the equipment 300. FIG. 15B illustrates the equipment in the case of distance measurement in front of the vehicle (distance measurement range 350). The vehicle information acquisition device 310 serving as the distance measurement control unit sends an instruction to the equipment 300 or the distance measuring unit 303 to perform the distance measurement operation. With such a configuration, the accuracy of distance measurement may be further improved.

In the above description, an example in which control is performed so as not to collide with another vehicle has been described, but the present disclosure is also applicable to control in which automatic driving is performed so as to follow another vehicle, control in which automatic driving is performed so as not to protrude from a lane, and the like. Furthermore, the equipment is not limited to vehicles such as automobiles, and may be applied to a movable object (moving device), such as ships, aircrafts, artificial satellites, industrial robots, consumer robots, and the like. In addition, the present invention is not limited to movable object, and may be widely applied to devices utilizing object recognition or biological recognition, such as an ITS (Intelligent Transport Systems), a monitoring system, and the like.

### Modified Embodiments

The present disclosure is not limited to the above-described embodiments, and various modifications are possible.

For example, examples in which some of the configurations of any of the embodiments are added to other embodiments or examples in which some of the configurations of any of the embodiments are substituted with some of the configurations of the other embodiments are also an embodiment of the present disclosure.

In the above-described embodiments, the light emitting unit 10 and the light receiving unit 40 are described as a part of the components of the ranging device 100, but at least one of the light emitting unit 10 and the light receiving unit 40 does not necessarily need to be a part of the configuration of the ranging device 100.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for implementing the present disclosure, and the technical scope of the present disclosure should not be interpreted in a limited manner by these embodiments. That is, the present disclosure can be implemented in various forms without departing from the technical idea or the main feature thereof.

According to the embodiments of the present disclosure, in the ranging device and the ranging method that acquire distance information along the depth direction of the distance measurement range by performing measurement while sequentially shifting the exposure period, it is possible to reduce the time required to acquire the distance information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-094109, filed Jun. 7, 2023, which is hereby incorporated by reference herein in its entirety.

What is claimed is:

1. A ranging device comprising:
a light receiving unit configured to detect an optical signal including light emitted from a light emitting unit and reflected by an object in a measurement target region and convert the optical signal into a pulse signal;
an exposure period control unit configured to set the light receiving unit to one of a plurality of exposure periods set corresponding to a plurality of classes defined according to a time from emission of the light to detection of the light for each light emission of the light emitting unit;
an information generation unit configured to generate information indicating a relationship between the class and a frequency indicating the number of times the pulse signal is detected, based on a signal output from the light receiving unit during a predetermined frame period including a plurality of light emissions of the light emitting unit; and
a peak determination unit configured to determine a peak of the frequency in the information,
wherein, when the peak of the frequency is detected in the information acquired in a first frame period, in a second frame period subsequent to the first frame period, the exposure period control unit sets as the exposure period in order from a period closer to a period corresponding to a class in which the peak is detected.

2. The ranging device according to claim 1, wherein the second frame period continues until a peak corresponding to the peak is detected in any of the classes, and transitions to a next frame period without executing the exposure periods corresponding to the rest classes.

3. The ranging device according to claim 1, wherein, when the peak of the frequency is not detected in the information acquired in the first frame period, the exposure period control unit sequentially sets a plurality of periods corresponding to the plurality of classes as the exposure period in the second frame period.

4. The ranging device according to claim 2, wherein, when the peak of the frequency is not detected in the information acquired in the first frame period, the exposure period control unit sequentially sets a plurality of periods corresponding to the plurality of classes as the exposure period in the second frame period.

5. The ranging device according to claim 1, wherein the peak determination unit calculates distance information to the object based on time information corresponding to the class in which the peak is detected.

6. The ranging device according to claim 2, wherein the peak determination unit calculates distance information to the object based on time information corresponding to the class in which the peak is detected.

7. The ranging device according to claim 1, further comprising a speed information acquisition unit configured to acquire speed information indicating a relative moving speed with respect to the object,
wherein the exposure period control unit calculate a period corresponding to the class in which the peak is detected in consideration of the speed information.

8. The ranging device according to claim 2, further comprising a speed information acquisition unit configured to acquire speed information indicating a relative moving speed with respect to the object,
wherein the exposure period control unit calculate a period corresponding to the class in which the peak is detected in consideration of the speed information.

9. The ranging device according to claim 1, wherein, when a predetermined number of frame periods in which the peak of the frequency is detected in the information acquired in a previous frame period are consecutive, the exposure period control unit sequentially sets a plurality of periods corresponding to the plurality of classes as the exposure period in a next frame period.

10. The ranging device according to claim 2, wherein, when a predetermined number of frame periods in which the peak of the frequency is detected in the information acquired in a previous frame period are consecutive, the exposure period control unit sequentially sets a plurality of periods corresponding to the plurality of classes as the exposure period in a next frame period.

11. The ranging device according to claim 1,
wherein the light receiving unit includes a plurality of regions each including a plurality of pixels,
wherein the exposure period control unit sets the exposure period independently for each of the plurality of regions, and
wherein the information generation unit generates a plurality of the information corresponding to the plurality of regions.

12. The ranging device according to claim 2,
wherein the light receiving unit includes a plurality of regions each including a plurality of pixels,
wherein the exposure period control unit sets the exposure period independently for each of the plurality of regions, and
wherein the information generation unit generates a plurality of the information corresponding to the plurality of regions.

13. The ranging device according to claim 1,
wherein the frame period includes a plurality of sub-frames, and
wherein each of the plurality of sub-frames includes a plurality of times of light emission of the light emitting unit, and the same exposure period is set with respect to the plurality of times of light emission for each of the plurality of sub-frames.

14. The ranging device according to claim 2,
wherein the frame period includes a plurality of sub-frames, and
wherein each of the plurality of sub-frames includes a plurality of times of light emission of the light emitting unit, and the same exposure period is set with respect to the plurality of times of light emission for each of the plurality of sub-frames.

15. A ranging device comprising:
a light receiving unit configured to detect an optical signal including light emitted from a light emitting unit and reflected by an object in a measurement target region and convert the optical signal into a pulse signal;
an exposure period control unit configured to set the light receiving unit to one of a plurality of exposure periods set corresponding to a plurality of classes defined according to a time from emission of the light to detection of the light for each light emission of the light emitting unit;
an information generation unit configured to generate information indicating a relationship between the class and a frequency indicating the number of times the pulse signal is detected, based on a signal output from the light receiving unit during a predetermined frame period including a plurality of light emissions of the light emitting unit; and
a distance information acquisition unit configured to acquire distance information related to the object from outside,
wherein the exposure period control unit sets the exposure period as the exposure period in order from a period closer to a period corresponding to the distance information acquired by the distance information acquisition unit.

16. A movable object comprising:
the ranging device according to claim 1, and
a control device configured to control the movable object based on distance information acquired by the ranging device.

17. A movable object comprising:
the ranging device according to claim 1, and
a control device configured to control the movable object based on distance information acquired by the ranging device.

18. A ranging method that detects an optical signal including light emitted from a light emitting unit and reflected by an object in a measurement target region and calculates a distance to the object based on the detected signal, the method comprising:
setting a light receiving unit to one of a plurality of exposure periods set corresponding to a plurality of classes defined according to a time from emission of the light to detection of the light for each light emission of the light emitting unit, and converting a signal detected by the light receiving unit to a pulse signal;
generating information indicating a relationship between the class and a frequency indicating the number of times the pulse signal is detected, based on a signal output from the light receiving unit during a predetermined frame period including a plurality of light emissions of the light emitting unit; and
when the peak of the frequency is detected in the information acquired in a first frame period, in a second frame period subsequent to the first frame period, setting as the exposure period in order from a period closer to a period corresponding to a class in which the peak is detected.
